(19) United States
(12) Patent Application Publication
(10) Pub. No.: US 2024/0283532 A1
(43) Pub. Date: Aug. 22, 2024

(54) ALL-OPTICAL OPEN CABLE OSNR MEASUREMENT

(71) Applicant: EXFO Inc., Quebec (CA)

(72) Inventors: Gang HE, Quebec (CA); Gwennael AMICE, St-Lambert (CA)

(21) Appl. No.: 18/392,359

(22) Filed: Dec. 21, 2023

Related U.S. Application Data
(60) Provisional application No. 63/485,973, filed on Feb. 20, 2023.
(60) Provisional application No. 63/607,585, filed on Dec. 8, 2023.

(51) Int. Cl. H04B 10/077; H04B 10/079

(52) U.S. Cl. CPC H04B 10/0775; H04B 10/0795

(57) ABSTRACT

There are herein provided methods and systems to characterize optical propagation characteristics of an optical fiber communication link (such as, e.g., a submarine line system), including ASE noise (such as traditional OSNR_{ASE}), non-linear noise (such as OSNR_{NL} due to nonlinear distortions) and/or the GOSNR. The method uses a polarized probe signal in the optical transmission channel under test in order to probe the link under test, as well as power loading light in other optical transmission channels in order to activate non-linear effects. The propagated test signal is then analyzed under varied polarization conditions using a varied-SOP polarization-resolved optical spectrum analysis of the propagated probe signal.

### TECHNICAL FIELD

The present description generally relates to measurement techniques for characterizing the propagation characteristics of an optical fiber communication system, and more specifically for characterizing the Optical Signal to Noise Ratio (OSNR) as well as non-linear transmission characteristics, the Polarization Dependent Loss (PDL) and/or the Differential Group Delay (DGD) of an optical fiber communication link.

### BACKGROUND

Network operators increasingly adopt practices of network function disaggregation (also referred to in the industry as the “open cable” concept), including sourcing the terminal equipment (transceivers and transponders) and the optical transmission link (such as a submarine cable, including amplifiers and ROADMs) from different vendors.

The need to fully characterize the transfer function of the amplified optical fiber communication link is therefore becoming vital. In the last decade, the system vendors have tried to unify the various methodologies into a standard that would be capable of providing a complete characterization of the submarine cables. With the introduction of coherent modems on submarine cables, characterization based only on signal ratio to amplified spontaneous emission noise is clearly insufficient to account for nonlinear effects and polarization effects.

Increased use of coherent receivers operating without optical dispersion compensation has led to the definition of the concept of a Generalized Optical Signal to Noise Ratio (GOSNR) which combines in a single metric (i.e., the GOSNR), both the traditional OSNR_{ASE} due to amplified spontaneous emission noise from optical amplifiers, and the “nonlinear” OSNR_{NL} due to nonlinear distortions. The GOSNR quantifies the linear and nonlinear noise accrued by a signal while passing through an optical link consisting of fiber spans and amplifiers. The GOSNR metric is particularly useful in disaggregated systems, where it is desirable to quantify the optical link performance independently of the terminal equipment.

There exist known methods in art for deriving the GOSNR using a pair of coherent transponders (see P. Pecci et al., “Experimental Characterization of Submarine “Open Cable” using Gaussian-noise Model and OSNR_{WET} Parameter,” Proc. OFC 2017, M2E. 4). But such GOSNR measurement methods have a dependence on the transponder's implementation including the transceiver optics, electronics, digital signal processing, nonlinear compensation algorithms, modulation schemes, etc. For repeatable and reproducible measurements, the procedure requires “golden” transceivers (as opposed to “commercial-grade” transceivers) for both back-to-back and the end-to-end measurements, i.e., transceivers having intrinsic Q that is one or two orders of magnitude higher than measured Q. Relying on rare and expensive golden transceivers is not very practical.

An ideal characterization technique would be fully transponder-agnostic.

Furthermore, GSNR and GOSNR characterization of older submarine cables implementing fiber-based chromatic dispersion compensation is ever further complicated. The full discrimination of all propagation impairments is hazardous on these cables using the coherent transponder-based method.

There is therefore a need for a transponder-agnostic measurement methods for characterizing a noise parameter (such as the OSNR_{ASE}, the OSNR_{NL} or the GOSNR) characterizing an optical fiber communication link under test, and which does not require golden coherent transceivers to perform the measurement.

### SUMMARY

There are herein provided methods and systems to characterize optical propagation characteristics of an optical fiber communication link (such as, e.g., a submarine line system), including ASE noise (such as traditional OSNR_{ASE}), non-linear noise (such as OSNR_{NL} due to nonlinear distortions) and/or the GOSNR. The method uses a polarized probe signal in the optical transmission channel under test in order to probe the link under test, as well as power loading light in other optical transmission channels in order to emulate in-operation transmission conditions. The propagated test signal is then analyzed under varied polarization conditions using a varied-SOP polarization-resolved optical spectrum analysis of the propagated probe signal.

This technique may be used to measure ASE noise with improved accuracy and/or non-linear optical noise. The test system can be used to further characterize polarization effects, such as Differential Group Delay (DGD), Polarization Mode Dispersion (PMD) and/or Polarization Dependent Loss (PDL) along the optical fiber communication link. This approach complements transponder-based metrics (such as ESNR and GSNR) with optical measurements (i.e., transponder-agnostic) suitable for pre-deployment assessment and compensated wet plant.

The proposed solution is based on varied-SOP polarization-resolved optical spectrum analysis. In some embodiments, the solution may be implemented using a single-channel or a dual-channel Varied-SOP polarization-resolved Optical Spectral Analyzer (VSOP-OSA).

The VSOP-OSA combines the advantages of relative insensitivity to environmentally induced SOP variations and the high measurement accuracy of multiple impairments by using polarization-resolved optical spectrum analysis.

In accordance with one aspect, there is provided a method for determining a noise parameter characterizing an optical fiber communication link under test within an optical transmission channel under test, independently of the terminal equipment. The method comprises:
generating a test signal comprising a polarized probe signal within the optical transmission channel under test, and power loading light in a plurality of channels outside the optical transmission channel under test;
propagating the test signal in the optical fiber communication link under test from one end thereof;
on the other end of the optical communication link under test, analyzing the propagated test signal using a varied-SOP polarization-resolved Optical Spectral Analyzer (VSOP-OSA), said analyzing comprising acquiring, for each of a number nSOP of varied state-of-polarization analysis conditions, at least one polarization-analyzed optical spectrum trace, said propagated test signal comprising a probe signal contribution, an ASE-noise contribution and a non-linear optical noise contribution within said optical transmission channel;
mathematically discriminating said signal contribution from at least said ASE-noise contribution using the polarization-analyzed optical spectrum traces acquired under varied state-of-polarization analysis conditions; and
determining said noise parameter characterizing said optical fiber communication link under test under test within said optical transmission channel using said probe signal contribution and at least the discriminated ASE-noise contribution.

In accordance with another aspect, there is provided a test system for determining a noise parameter characterizing an optical fiber communication link under test within an optical transmission channel, independently of the terminal equipment. The test system comprises:
a polarized light source to generate a polarized probe signal within the optical transmission channel under test;
a power loading light source to generate power loading light in a plurality of channels outside the optical transmission channel under test;
wherein said probe signal and said power loading light are combined to generate a test signal to be propagated in the optical fiber communication link under test from one end thereof;
a varied-SOP polarization-resolved Optical Spectral Analyzer (VSOP-OSA) on the other end of the optical communication link under test, to analyze the test signal having propagated in the optical fiber communication link under test, said VSOP-OSA comprising a polarization scrambler to acquire, for each of a number nSOP of varied state-of-polarization analysis conditions, at least one polarization-analyzed optical spectrum trace, said propagated test signal comprising a probe signal contribution, an ASE-noise contribution and a non-linear optical noise contribution within said optical transmission channel; and
a processing unit receiving the polarization-analyzed optical spectrum traces acquired under varied state-of-polarization analysis conditions and configured to:
   mathematically discriminate said signal contribution from at least said ASE-noise contribution using the polarization-analyzed optical spectrum traces acquired under varied state-of-polarization analysis conditions; and
   determine said noise parameter characterizing said optical fiber communication link under test under test within first optical transmission channel using said probe signal contribution and at least the discriminated ASE-noise contribution.

It should be noted that the proposed solution may advantageously allow to characterize both the OSNR_{ASE} and the OSNR_{NL} in one measurement step, whereas the coherent transponder-based method requires two measurement steps, one to characterize the OSNR_{ASE} and another for the GOSNR.

For example, the all optical VSOP-OSA approach may find applications in field deployment to accelerate, improve and/or complement the current methodologies used by operators and system vendors to validate the capacity of submarine links to support the next generation of high-speed transponders.

Further features and advantages of the present invention will become apparent to those of ordinary skill in the art upon reading of the following description, taken in conjunction with the appended drawings.

The following description is provided to gain a comprehensive understanding of the methods, apparatus and/or systems described herein. Various changes, modifications, and equivalents of the methods, apparatuses and/or systems described herein will suggest themselves to those of ordinary skill in the art. Description of well-known functions and structures may be omitted to enhance clarity and conciseness.

Although some features may be described with respect to individual exemplary embodiments, aspects need not be limited thereto such that features from one or more exemplary embodiments may be combinable with other features from one or more exemplary embodiments.

### BRIEF DESCRIPTION OF THE DRAWINGS

FIG. 1 is a block diagram illustrating a typical test system for an open cable characterization.

FIGS. 2A and 2B are graphs schematically illustrating example test signals which may be generated by the test system of FIG. 1, wherein FIG. 2A illustrates a case wherein the power loading light is generated by a plurality of coherent transceivers and FIG. 2B illustrates a case wherein the power loading light comprises two adjacent coherent transmitter signals and ASE light in other channels.

FIG. 3 is a block diagram illustrating a test system for determining a noise parameter characterizing an optical fiber communication link under test, in accordance with one embodiment.

FIGS. 4A, 4B, 4C and 4D are graphs schematically illustrating example test signals which may be generated by the test system of FIG. 3, wherein FIG. 4A illustrates a case wherein the power loading light is generated by a plurality of coherent transceivers or polarized transceivers, FIG. 4B illustrates a case wherein the power loading light comprises two adjacent coherent transmitter signals and ASE light in other channels, FIG. 4C illustrates a case wherein the power loading light comprises ASE light only, and FIG. 4D illustrates a case wherein the test signal comprise a plurality of probe signals and power loading light in other transmission channels that are empty of a probe signal.

FIG. 5 is a block diagram illustrating a test system for determining a noise parameter characterizing an optical fiber communication link under test, in accordance with another embodiment wherein the power loading light is generated by a polarized broadband light source followed by a high-speed polarization scrambler.

FIG. 6 is a schematic illustrating a dual-channel Varied-SOP polarization-resolved Optical Spectral Analyzer (VSOP-OSA), in accordance with one embodiment.

FIG. 7 is a flowchart illustrating a method for determining a noise parameter characterizing an optical fiber communication link under test, in accordance with one embodiment.

FIG. 8 is a schematic illustrating a Varied-SOP polarization-resolved Optical Spectral Analyzer (VSOP-OSA), in accordance with one embodiment wherein the VSOP-OSA is single channel.

FIG. 9 is a schematic illustrating a Varied-SOP polarization-resolved Optical Spectral Analyzer (VSOP-OSA) in accordance with one embodiment wherein a dual-channel polarization-independent OSA is used but only one channel is polarization-resolved.

FIG. 10 is a block diagram illustrating an example architecture of a VSOP-OSA, in accordance with one embodiment.

It will be noted that throughout the drawings, like features are identified by like reference numerals. In the following description, similar features in the drawings have been given similar reference numerals and, to not unduly encumber the figures, some elements may not be indicated on some figures if they were already identified in a preceding figure. It should be understood herein that elements of the drawings are not necessarily depicted to scale, since emphasis is placed upon clearly illustrating the elements and structures of the present embodiments. Some mechanical or other physical components may also be omitted in order to not encumber the figures.

### DETAILED DESCRIPTION

### Coherent Transponder-Based Method:

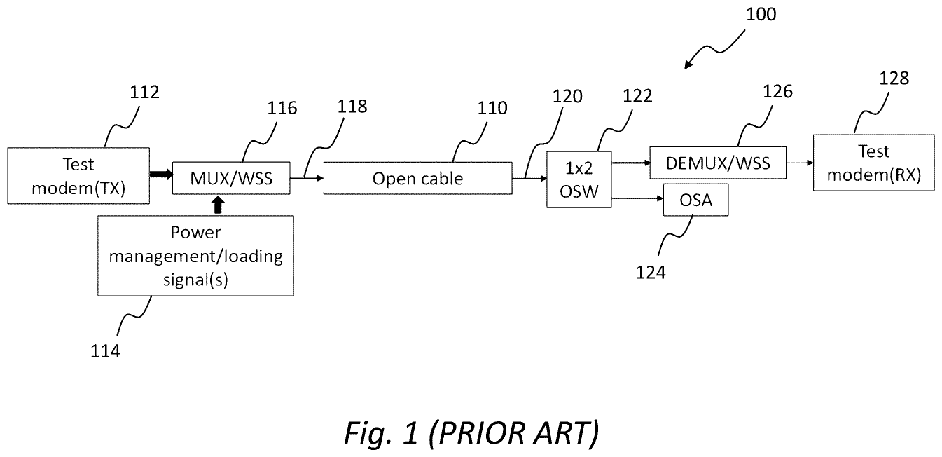

FIG. 1 illustrates a typical test system 100 for an open cable characterization currently used in the industry at time of commissioning a new optical fiber communication link 110.

The test system 100 comprises of a first test transponder 112 (also referred to as a modem) acting as a transceiver to generate a probe signal within an optical channel under test, and a power loading light source 114, which outputs are combined with a multiplexer or wavelength selective switch 116 to generate a test signal 118 which is launched into the optical fiber communication link under test 110. At the other end of the optical fiber communication link 110, the propagated test signal 120 is split towards an Optical Spectrum Analyzer (OSA) 124 and a second test transponder 128 acting as a receiver preceded by a multiplexer or wavelength selective switch 126 used to remove any light power outside of the bandwidth of the test signal.

The traditional OSNR_{ASE} due to ASE noise is measured by the OSA 124 using the commonly known “ON/OFF” method, whereas and the GOSNR or the GSNR is measured using the test transponders. The full characterization therefore requires two measurement steps. It is noted that the GOSNR characterizes the combination of both ASE-noise (OSNR_{ASE}) and non-linear noise (OSNR_{NL}), wherein:

$$1 / GOSNR = 1 / {OSNR}_{ASE} + 1 / {OSNR}_{NL} \qquad ( 1 )$$

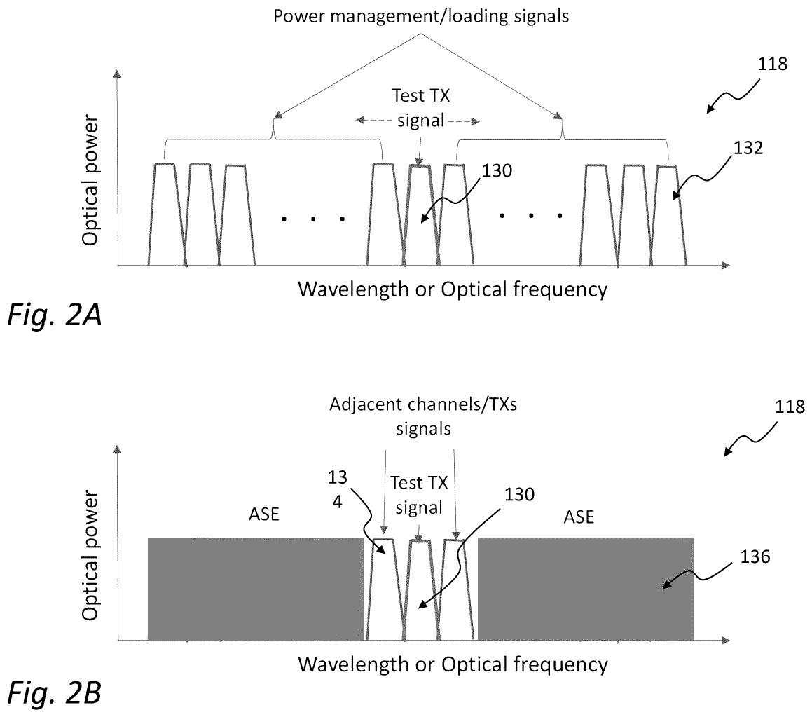

FIGS. 2A and 2B schematically illustrate example test signals 118 which may be generated by the test system which includes the transponder on the transmission side, which test signal 118 is launched into the optical fiber communication link under test 110. The test signal 118 comprises a probe signal 130 and power loading light 132 As per FIG. 2A, in some implementations, the power loading light may be generated by a plurality of coherent transmitters (e.g., bulk-modulated QPSK Polmux transmitters). Such system may be used for characterization of both chromatic dispersion compensated links and non-compensated links. As per FIG. 2B, in non-compensated links, the test signal 118 may consist of a probe signal 130, two adjacent coherent transmitter (idle) signals 134 and ASE light 136.

The probe signal 130 may be tuned in wavelength in order to allow characterization of the optical fiber communication link 110 over the whole operating range, e.g., over the C-band of ITU-T.

The main drawback of the above coherent transponder-based method are the dependence upon the transponder's impairments in the transceiver optics, electronics, digital signal processing, nonlinear compensation algorithms, modulation schemes, etc.

### Proposed Optical (OSA-Based) Method:

The proposed measurement method is based on the acquisition of multiple polarization-analyzed optical spectrum traces, each corresponding to a different polarization-analyzer conditions, or equivalently to a different state of polarization (SOP) of the light impinging upon the analyzer.

The method uses a polarized probe signal in the optical transmission channel under test in order to probe the link under test, as well as power loading light in other optical transmission channels in order to activate non-linear effects. The propagated test signal is then analyzed under varied polarization conditions using a varied-SOP polarization-resolved optical spectrum analysis of the propagated probe signal.

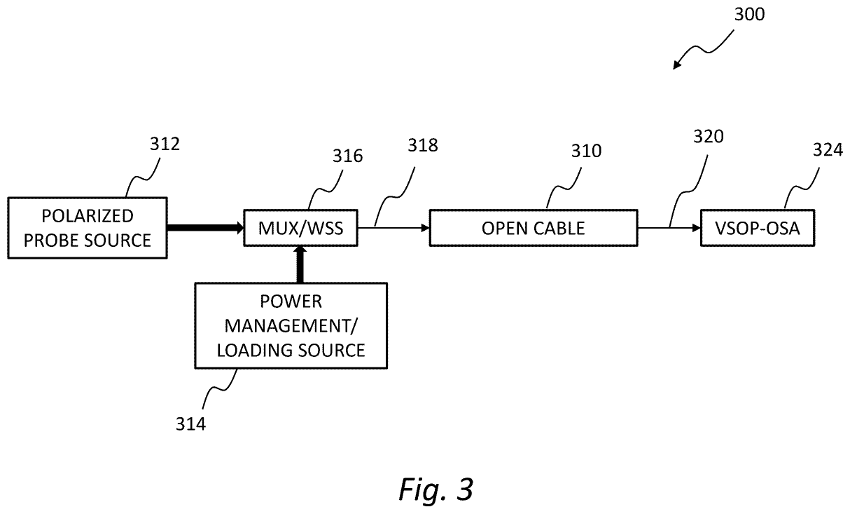

FIG. 3 illustrates the test system 300 in accordance with one embodiment. As shown, instead of the test transponder 112 of FIG. 1, a polarized light source 312 is used to generate a probe signal to be launched into the optical communication link 310 under test. The test system 300 comprises of a polarized light source 312 to generate a probe signal within an optical channel under test, and a power loading light source 314, which outputs are combined with a multiplexer or wavelength selective switch 316 to generate a test signal 318 which is launched into the optical fiber communication link under test 310. For example, the polarized light source 312 may be implemented using a laser source (continuous wave) or a single-polarization transponder (modulated signal). At the other end of the optical fiber communication link 310, the propagated test signal 320 is analyzed using a Varied-SOP polarization-resolved Optical Spectral Analyzer (VSOP-OSA) 324.

It is noted that the polarized light source 312 may be replaced by a plurality of polarized light sources multiplexed to generate a test signal comprising a plurality of probe signals at different wavelengths corresponding to a plurality of optical channels under test. Such configuration may allow to measure noise parameters over multiple channels simultaneously. For example, the test signal may comprise 6 or more probe signals.

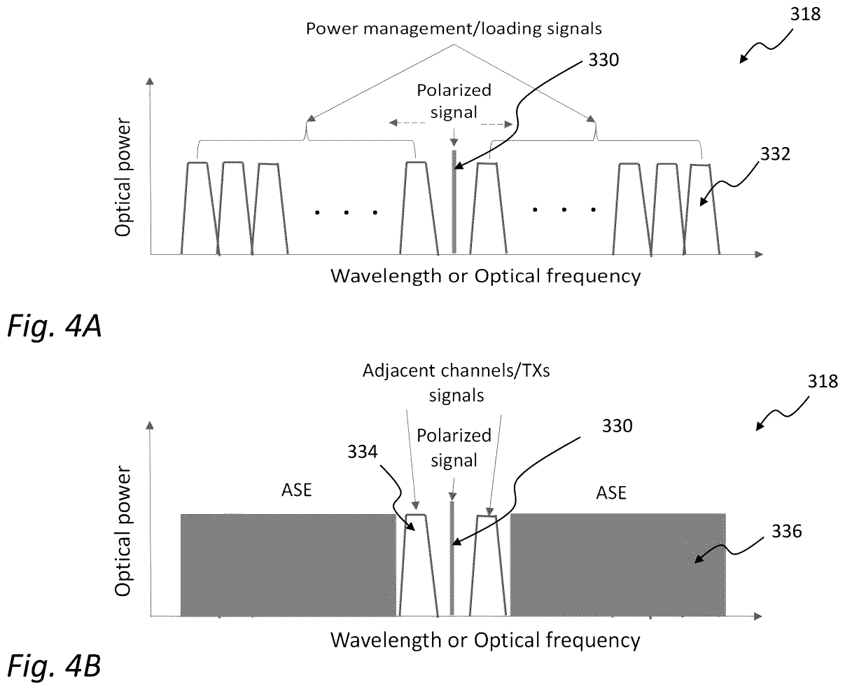

FIGS. 4A, 4B, 4C and 4D schematically illustrate example test signals 318 which may be generated by the test system 300, which test signal 318 is to be launched into the optical fiber communication link under test 310. The test signal 318 comprises a probe signal 330 and power loading light 332. As per FIG. 4A, the power loading light 332 may be generated by a plurality of coherent transceivers (e.g., bulk-modulated QPSK Polmux transmitters) or polarized transceivers. As per FIG. 4B, in some implementations, the power loading light 332 may comprise two coherent transmitter (idle) signals 334, one on each side of the probe signal 330, and ASE light 336 in all other Wavelength Division Multiplexed (WDM) channels over the operating range of the optical fiber communication system. The ASE light 336 is used to replace light that would be present in other WDM channels during normal operation of the optical fiber communication system. The more the power loading signals will be representative of normal operation, the more precise will be measured parameters.

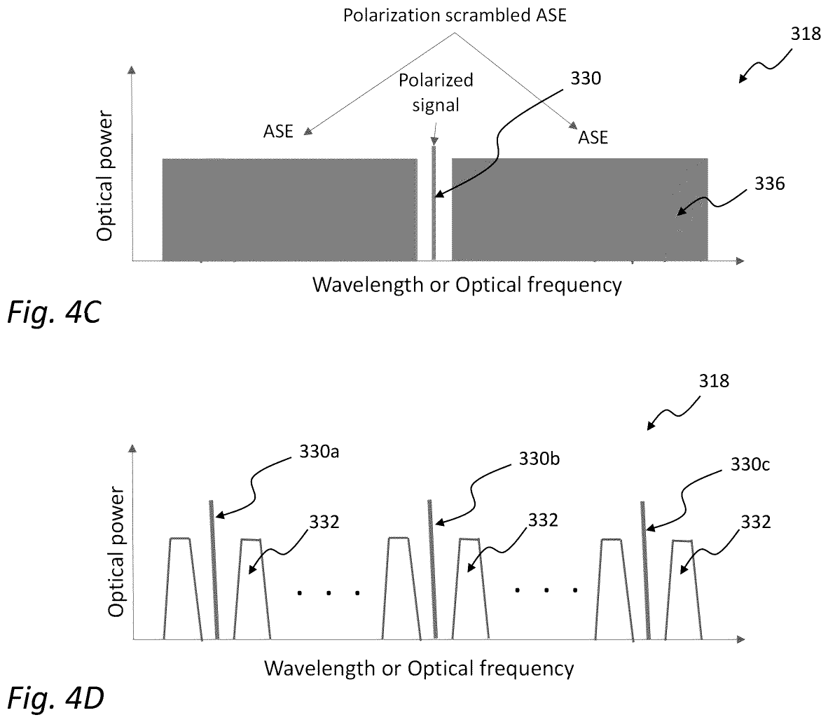

As per FIG. 4C, in some less expensive implementations, the power loading light 332 may comprises ASE light 336 only. Referring to FIG. 5, in some embodiments, an unpolarized-equivalent broadband power loading light 332 may be generated using a polarized broadband light source 502 (e.g., from a Semiconductor Optical Amplifier (SOA)) followed by a high-speed polarization scrambler 504. Or in other implementations, a modulated broadband light source may be used. As shown in FIG. 5, an amplifier and/or a variable optical attenuator 506 may also be added on the transmission side to control the power level of the test signal 318.

In some embodiments, the polarized light source 312 may be implemented using a Continuous Wave (CW) single longitudinal mode (SLM) laser source. A CW-SLM laser source is much less expensive than a transceiver, which lowers the cost of the test system 300 compared to the coherent transponder-based method.

As illustrated in FIG. 4D, in some embodiments, the low cost may be particularly advantageous for implementing a multiple probe configuration for parallel measurement in a plurality of optical transmission channels. In such embodiments, the test signal 318 may comprise a plurality of probe signals 330a, 330b, 330c and power loading light 332 in other transmission channels that are empty of a probe signal.

In other embodiments, the polarized light source 312 may be made tunable in wavelength in order to allow characterization of the optical fiber communication link 310 over the whole operating range, e.g., over the C-band of ITU-T.

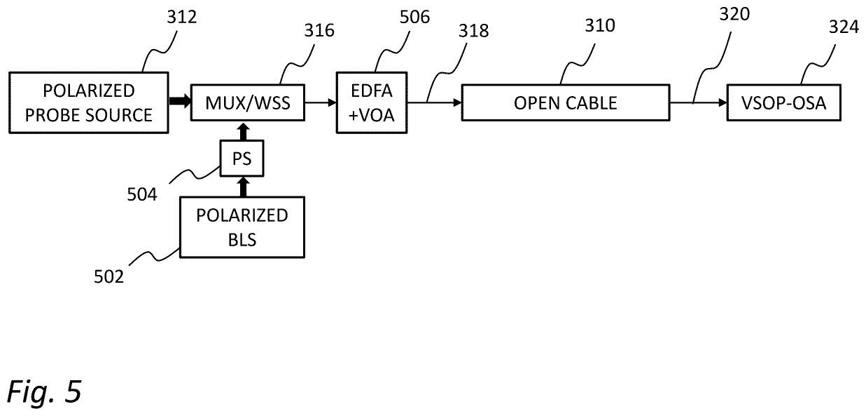

Referring to FIG. 6, the VSOP-OSA 324 is now described in more detail. The VSOP-OSA 324 receives the propagated test signal 320 to be analyzed. It comprises a polarization scrambler 602 (also elsewhere denoted polarization controller) disposed at the input of a dual-channel polarization-diversity OSA 604. The polarization-diversity OSA 604 comprises a polarization beam splitter 606 and a dual-channel Optical Spectrum Analyser (OSA) 608.

The polarization beam splitter 606 is used to obtain two orthogonally-analyzed signals P_{//} and P_{⊥} of the input optical signal Pᵢₙ. The OSA 608 simultaneously acquires two polarization-analyzed optical spectrum traces (P_{//}(λ) and P_{⊥}(λ) or, equivalently, P_{//}(ν) and P_{⊥}(ν)) of the signal P_{//} and P_{⊥}, respectively. The polarization scrambler 602 varies the state-of-polarization analysis conditions between consecutive acquisitions of signals P_{//} and P_{⊥}.

The main advantages of VSOP-OSA 324 include its relative insensitivity to environmentally induced SOP variations (both are similar in nature) that are often encountered in the field and the high accuracy that may be obtained via power-related polarization spectrum analysis.

The measured optical power spectra correspond to the optical input signal such that:

$${p}_{sum} ( v ) = {P}_{//} ( v ) + {P}_{⊥} ( v ) = {p}_{in} ( v ) * f ( v ) , \qquad ( 2 )$$

wherein “*” denotes the convolution operation and f(ν) is the “spectral filter response function” of OSA.

The measured optical spectrum P(ν) comprises a signal contribution S(ν) (free of ASE noise) and an ASE noise contribution N(ν) such that

$${P}_{sum} ( v ) = S ( v ) + {N}_{ASE ( v )} \qquad ( 3 )$$

$${P}_{sum} ( v ) = [ s ( v ) + n ( v ) ] * f ( v ) \qquad ( 4 )$$

The respective contributions of the signal S(λ) and noise N(λ) are not initially known and these are yet to be estimated. As described above, two samples P_{//} and P_{⊥} are produced from the input optical signal pᵢₙ using mutually-orthogonal state-of-polarization analysis conditions. The pair of mutually-orthogonal optical spectra P_{//}(ν) and P_{⊥}(ν), respectively corresponding to the two samples P_{//} and P_{⊥}, are acquired. The signal contribution, as well as the noise contribution, is split among the two samples P_{//} and P_{⊥} such that one of the two optical spectra P_{//}(ν) and P_{⊥}(ν) generally comprises a larger proportion of the signal contribution.

For each of n_{SOP} varied SOP analysis conditions generated by the polarization scrambler 602, the VSOP-OSA scans across the operating range of the optical fiber communication system. Accordingly, n_{SOP} pairs of relative traces (T_{//}(ν) and T_{⊥}(ν)) of mutually orthogonal polarization-analyzed traces are acquired as:

$${T}_{//} ( v ) = {P}_{//} ( v ) / {P}_{sum} ( v ) \qquad ( 5 a )$$

$${T}_{⊥} ( v ) = {P}_{⊥} ( v ) / {p}_{sum} ( v ) \qquad ( 5 b )$$

$${P}_{sum} ( v ) = {P}_{//} ( v ) + {P}_{⊥} ( v ) \qquad ( 5 c )$$

### In-Band OSNR Measurement:

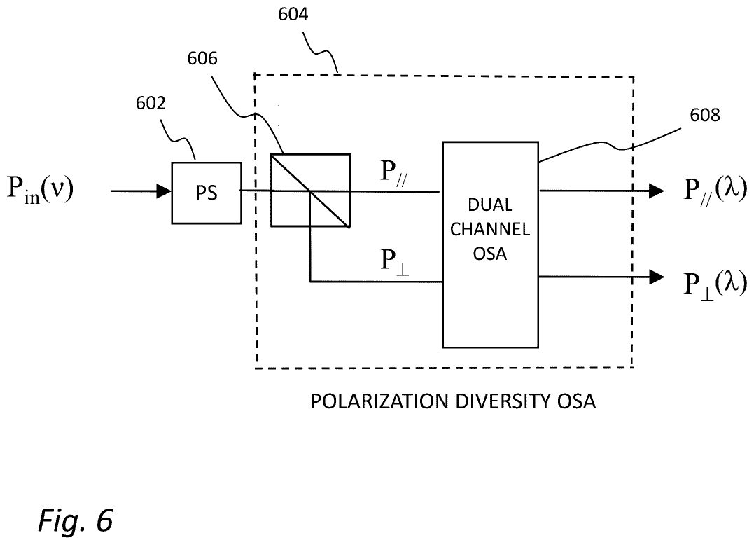

Referring to FIG. 7, a method of determining a noise parameter characterizing an optical fiber communication link under test within an optical transmission channel is now described. The calculations are mainly based on the differential polarization response (D-Pol) approach described in U.S. Pat. Nos. 8,364,034 and 9,438,336 (commonly owned by the Applicant and hereby incorporated by reference), bust is adapted to the method and the test system which are different. The differential polarization response methods involve the polarization-resolved detection of an optical spectrum with optical spectrum analyzer means, where two or more optical spectrum traces are acquired under different polarization analysis conditions. However, unlike polarization-nulling methods, the differential polarization response approach does not require that the polarized signal be suppressed for any of the acquired optical spectrum traces. Instead, the method allows to distinguish the signal contribution from the superposed in-band ASE noise by exploiting their differential polarization and spectral properties. The differential polarization response methods employ a mathematical discrimination of the signal peak from the in-band ASE noise in the acquired optical spectrum traces using calculations and comparisons between the acquired polarization-resolved traces.

In addition, a depolarized signal contribution (e.g., induced by PMD or/and nonlinear birefringence effects) may also be quantified, allowing it to be considered as being part of either the signal or non-linear noise in the subsequent analysis.

There is however a key difference between the herein-described method and the approach described in U.S. Pat. Nos. 8,364,034 and 9,438,336. In the later, the signal being characterized is a live data-carrying signal, whereas in the herein-described method, the signal is a probe signal which does not need to be modulated. It only has to be polarized.

In step 702, a test signal 318 is generated as described herein above. The test signal 318 comprises at least one polarized probe signal within a corresponding optical transmission channel of the optical fiber communication link and power loading light in channels outside the optical transmission channel(s) under test.

In step 704, the test signal is propagated in the of the optical fiber communication link under test 310.

In step 706, on the other end of the optical communication link under test 310, the propagated test signal 320 is analyzed using a varied-SOP polarization-resolved Optical Spectral Analyzer (VSOP-OSA). The analysis may comprise acquiring, for each of a number n_{SOP} of varied state-of-polarization analysis conditions, at least one polarization-analyzed optical spectrum trace. In the embodiment of FIG. 6, a pair of orthogonally-analyzed optical spectrum traces are acquired for each of the n_{SOP} analysis conditions.

After having propagated in the optical communication link 310, the test signal comprises a probe signal contribution, an ASE-noise contribution and a non-linear optical noise contribution within said optical transmission channel.

In step 708, the signal contribution may be discriminated from the ASE-noise contribution and the non-linear optical noise contribution by mathematically processing the n_{SOP} polarization-analyzed optical spectrum traces or the n_{SOP} pairs polarization-analyzed optical spectrum traces (embodiment of FIG. 6). For now on, it will be assumed that, as in the embodiment of FIG. 6, a pair orthogonally-analyzed optical spectrum traces are acquired for each of the n_{SOP} analysis conditions. But it will be understood that the processing may be adapted to embodiments where a single optical spectrum trace is acquired for each of the nso_{P} analysis conditions.

In order to perform a polarization analysis of the propagated test signal, extrema traces are calculated, i.e., a maxima transmission trace Tₘₐₓ(ν) and/or a minima transmission trace Tₘᵢₙ(ν), from the n_{SOP} pairs of mutually-orthogonal polarization-analyzed optical spectrum traces P_{//(}ν) and P_{⊥}(ν). In this embodiment, for each pair of said mutually-orthogonal polarization-analyzed optical spectrum traces P_{//}(ν) and P_{⊥}(ν), transmission traces T_{//}(ν) and Ti(ν) are obtained from equations (5a) and (5b).

From the n_{SOP} pairs of optical spectrum traces acquired, extrema transmittance traces, i.e. a minimum trace Tₘᵢₙ(ν) and a maximum trace Tₘₐₓ(ν), are determined. The minimum trace Tₘᵢₙ(ν) and maximum trace Tₘₐₓ(ν) are determined from the n_{SOP} acquired pairs of mutually-orthogonal transmittance data sets by selecting, at each measured wavelength among all 2n_{SOP} acquired traces, the minimum and maximum transmittances. The synthesis of the extrema transmittance traces

$${T}_{min} ( v ) = min {\{ {T}_{//} ( v ) ; {T}_{⊥} ( v ) \}}_{SOP} \qquad ( 6 a )$$

$${T}_{max} ( v ) = max {\{ {T}_{//} ( v ) ; {T}_{⊥} ( v ) \}}_{SOP} \qquad ( 6 b )$$

where min_{{x}SOP} and max_{{x}SOP} indicate “min-selecting” and “max-selecting” operations on the set of values for different SOPs at each individual wavelength. Any variation in the overall optical power from one acquired extrema-ratio trace to another can be compensated (“normalized”) in the data analysis using the corresponding Pₛᵤₘ(ν). In this way, one can obtain a constructed “min-selecting” composite extrema-power spectral trace Pₘᵢₙ(ν) and a constructed “max-selecting” composite extrema-power spectral trace Pₘₐₓ(ν) as

$${P}_{min} ( 𝓋 ) = {T}_{min} ( 𝓋 ) {P}_{sum} ( 𝓋 ) \qquad ( 7 a )$$

$${P}_{max} ( 𝓋 ) = {T}_{max} ( 𝓋 ) {P}_{sum} ( 𝓋 ) \qquad ( 7 b )$$

Accordingly, in this embodiment, the extrema traces Pₘᵢₙ(ν), Pₘₐₓ(ν) are composite extrema traces in that they comprise extrema values evaluated for each individual acquisition wavelength. It is noted that, in the case of CW probe signals, the processing may be simplified. In this case, (non-composite) extrema transmittance traces, Tₘᵢₙ(ν) and Tₘₐₓ(ν) may be determined as the transmission trace, among all the 2n_{SOP} transmission traces (T_{//}(ν), T_{⊥}(ν)), showing the minimum/maximum value at the probe signal peak.

Note that the constructed composite extrema-power spectral traces Pₘᵢₙ(ν) and Pₘₐₓ(ν) effectively represent:

$${P}_{max} ( 𝓋 ) = κ {S}_{pl} ( 𝓋 ) + 0.5 {S}_{dp} ( 𝓋 ) + 0.5 {N}_{ASE} ( 𝓋 ) \qquad ( 8 a )$$

$${P}_{min} ( 𝓋 ) = ( 1 - κ ) {S}_{pl} ( 𝓋 ) + 0.5 {S}_{dp} ( 𝓋 ) + 0.5 {N}_{ASE} ( 𝓋 ) \qquad ( 8 b )$$

where K represents the portion of the polarized signal contribution that is measured in Pₘₐₓ(λ), N_{ASE}(λ) is ASE optical noise in propagated test signal, and Sₚₗ(λ) and S_{dp}(λ) are polarized and depolarized parts of the probe signal contribution, respectively, wherein

$$S ( 𝓋 ) = {S}_{pl} ( 𝓋 ) + {S}_{dp} ( 𝓋 ) . \qquad ( 9 )$$

By subtracting equation (8b) from equation (8a), one obtains the differential polarization response:

$$Δ P ( 𝓋 ) = {P}_{max} ( 𝓋 ) - {P}_{min} ( 𝓋 ) = ( 2 κ - 1 ) {S}_{pl} ( 𝓋 ) \qquad ( 10 )$$

The signal contribution (free of ASE) can be estimated from the difference of the polarization-resolved spectra:

$$S ( 𝓋 ) = K Δ P ( 𝓋 ) \qquad ( 11 )$$

$$wherein$$

$$K = {[ ( 2 κ - 1 ) ( 1 - {C}_{dp} ) ]}^{- 1} \qquad ( 12 )$$

$$and {C}_{dp} = {S}_{dp} / S represent a coefficient of signal depolarization .$$

The processing is carried out using measurements acquired at two distinct wavelengths or optical frequencies ν1 and ν2 that lie within the optical-signal bandwidth of the probe signal and are generally positioned on the same side of the peak (i.e., spectral midpoint) of the signal contribution S(A). Knowing that the ASE-noise contribution is known to be substantially flat in wavelength, ν1 and ν2 may be selected such that there is a substantially equal level of ASE-noise contribution N_{ASE}(λ) at ν1 and ν2 (i.e. Δ=N_{ASE}(ν1)−N_{ASE}(ν2)→0) and a different level of signal contribution in Pₛᵤₘ(ν) at ν1 and ν2 (i.e. Pₛᵤₘ(ν1)≠Pₛᵤₘ(ν2)). We then find:

$${P}_{sum} ( 𝓋 1 ) = S ( 𝓋 1 ) + {N}_{ASE} ( 𝓋 1 ) \qquad ( 13 a )$$

$${P}_{sum} ( 𝓋2 ) = S ( 𝓋 2 ) + {N}_{ASE} ( 𝓋 2 ) \qquad ( 13 b )$$

So, assuming that the ASE noise level is constant within signal bandwidth (BW_{sig}), we find that K can be evaluated from power difference of two or multiple wavelengths over the signal spectrum:

$$K = [ {P}_{sum} ( 𝓋 1 ) - {P}_{sum} ( 𝓋2 ) ] / [ Δ P ( 𝓋 1 ) - Δ P ( 𝓋 2 ) ] \qquad ( 14 )$$

More specifically, once the constant K is estimated, the signal contribution S(ν) can be calculated from equation (11). The ASE-noise contribution N_{ASE} can then be deduced from equation (3) (i.e., N_{ASE}(ν)=Pₛᵤₘ(ν)−S(ν)), wherein N_{ASE} is actually independent of the optical frequency/wavelength.

As described in U.S. Pat. No. 8,364,034, an ab initio statistical approach can be used to derive an estimated value of κ, from the probability density function as a function of the number and distribution of the SOPs on the Poincare sphere. When the SOPs are independently and uniformly distributed on the Poincaré sphere, the expectation value μ of the calculated probability distribution function yields the following (ab initio) estimate κ, as a function of the number n_{SOP} of different SOP values:

$$κ = 0. 5 [ ( 2 {n}_{SOP} + 1 ) / ( {n}_{SOP} + 1 ) ] \qquad ( 15 )$$

In step 710, one or more ASE noise parameters characterizing the optical fiber communication link under test 310 within an optical transmission channel may be determined from the probe signal contribution S(ν) and the discriminated ASE-noise contribution N_{ASE}.

Noise parameters such as the OSNR_{ASE} and/or equivalent optical SNR (OE-SNR) can be found as:

$${OSNR}_{ASE} = {R}_{r e f} {\int }_{B W s i g} S ( 𝓋 ) d λ / {N}_{ASE} \qquad ( 16 )$$

$$where {R}_{r e f} = ( 12.5 GHz / {BW}_{OSA} ) , and$$

$$OE - SNR = {R}_{s i g} {\int }_{B W s i g} S ( 𝓋 ) d λ / {N}_{ASE} \qquad ( 17 )$$

$$where {R}_{s i g} = ( BWsig / {BW}_{OSA} ) .$$

OE-SNR is equivalent to SNR_{ASE} and provides an optical signal to noise ratio independent of the signal bandwidth.

The ASE noise level and OSNR_{ASE} measurements are substantially insensitive to signal depolarization from NLE and PMD, which is important for NLE estimation described in the next section.

### In-Band Non-Linear Effect Factor (NLEF) Estimation

When multiple optical signals are transmitted through an optical fiber, the SOP of one polarized signal (such as the probe signal) can be affected or changed by other signals (acting as “pumps”). Such effects arise primarily from the optical Kerr effect, also known as the “nonlinear birefringence” (NLB), which has a different magnitude for parallel and perpendicular field components. In a DWDM system, the nonlinear birefringence gives rise to a rapid change of SOP of the signal. Such a nonlinear polarization effect leads to a time-dependent polarization variation on the time scale of symbol rates. This effect results in an apparent signal depolarization when the signal is detected with a low-speed detection system. This rapid NLE-induced temporal signal depolarization can be used to measure or estimate the NLE on the probe signal(s) having propagated in the optical communication link 310 under test.

S_{dp} in equations (8a) and (8b) can be divided into two parts, i.e., the NLE-induced signal depolarization (S_{dp-NLE}) and the DGD-induced signal depolarization (S_{dp-DGD}), wherein S_{dp}=(S_{dp-NLE})+(S_{dp-DGD}). We herein define the power ratio of total signal power over NLE-induced signal depolarization power (S/S_{dp-NLE}) as a Non-Linear Effect Factor (NLEF), which we use to evaluate non-linear transmission characteristics.

If κ is known from equation (15) and S(ν) is determined as per above, then Sₚₗ(ν) can be deduced, e.g., based on equation (10) (i.e., Sₚₗ(ν)=ΔP(ν)/(2κ−1)). Next, S_{dp}(ν) can be calculated, e.g., from equation (9) (i.e., S_{dp}(ν)=S(ν)−Sₚₗ(ν)).

It is noted that in embodiments wherein the polarized light source 312 is implemented using a Continuous Wave (CW) laser source, DGD-induced signal depolarization (S_{dp-DGD}) becomes negligible, i.e., S_{dp-DGD}≈0.

In such cases, once K is known from equation (14) and κ from equation (15) the NLEF may be directly obtained from the C_{dp} found in equation (12):

$$NLEF = 1 / {C}_{dp} . \qquad ( 18 )$$

In embodiments wherein the DGD-induced signal depolarization S_{dp-DGD} cannot be neglected (e.g., light source 312 is modulated), then the S_{dp_DGD} will need to be evaluated (e.g., from a prior evaluation of the DGD and thereby S_{dp_DGD}), in order to separate the NLE-induced signal depolarization S_{dp_NLE} from the DGD-induced signal depolarization S_{dp}.

The above allows, in step 708 of the method of FIG. 7, to discriminate the signal contribution (Sₚₗ) from the ASE-noise contribution (N_{ASE}) and the non-linear optical noise contribution (S_{dp-NLE}).

In step 710, one or more non-linear noise parameters characterizing the optical fiber communication link under test 310 within an optical transmission channel may then be determined from the probe signal contribution Sₚₗ(ν) and the discriminated non-linear optical noise contribution S_{dp} (and/or the coefficient of signal depolarization C_{dp}).

For example, step 710 may comprise the calculation of the NLEF and/or the OSNR_{NL} from the NLEF as:

$${OSNR}_{NL} = α / {C}_{dp} \qquad ( 19 )$$

wherein α is a constant scaling factor which relates the C_{dp} or the NLEF to the OSNR_{NL}.

As to the constant α, it is noted that we observed a very clear correlation between the measured nonlinear-induced signal depolarization and link nonlinear noise (obtained via the transponder-based method), and thus we can estimate OSNR_{NL}=α/C_{dp}. The value of a is determined based on the measured data at the optimum launch power, i.e., the nonlinear noise is equal to half of the linear ASE noise, as expected by the GN model theory. GOSNR can then be estimated as:

$$1 / GOSNR = 1 / {OSNR}_{A S E} + ( 1 / α ) {C}_{dp} . \qquad ( 20 )$$

The above-described method may be used to measure ASE noise with improved accuracy and/or non-linear optical noise. In addition, the test system can further be used to characterize other polarization effects, such as the Polarization Dependent Loss (PDL), the Differential Group Delay (DGD)) and/or the Polarization Mode Dispersion (PMD), along the optical fiber communication link. This automated approach complements transponder-based metrics (such as ESNR and GSNR) with transponder-agnostic physical measurements suitable for pre-deployment assessment and compensated wet plant.

### In-Channel DGD Measurement

Optionally, using a slight variation the test system of FIG. 3, the in-channel DGD can be measured by scrambled state-of-polarization (SOP) analysis (SSA) method. The method requires two probe signals with closely-spaced frequencies and having the same SOP injected in the system. The difference between the normalized transmitted power of each probe for each of many randomly-selected scrambled input and output SOPs (I-SOP and O-SOP, respectively) are measured. From these differences, the DGD can be estimated. The SSA-based DGD or PMD measurement method can extract accurate DGD (see equation (21)) or root mean square (RMS) DGD within the test light bandwidth, without being affected by ASE from the optical amplifiers, nonlinear depolarization, and transmitted light spectral shape, etc. Moreover, the method is also robust to modest polarization dependent loss or gain (PDL/G) in the light-paths under test. If measurements are taken on a sufficient number of DWDM channels, the fiber PMD can be estimated from an average (RMS) of these separated measured DGD values (see equation (22)).

Assuming that a “moderately-broadband” test light (i.e., sufficiently wide to encompass the spectral width of the lightpath) is injected into the lightpath-under-test (LPUT). The DGD, noted τ, can be expressed as a function of optical frequency (ν) using equation (21) if the SOPs of the light exiting the LPUT are randomly and uniformly distributed on the Poincare sphere:

$$τ ( 𝓋 ) = \frac{arc sin ( \sqrt{4.5 {〈 Δ {T}_{n}^{2} ( 𝓋 ) 〉}_{S O P} )}}{πΔ 𝓋} \qquad ( 21 )$$

wherein α₀=4.5 is a constant determined from theoretical considerations and ΔTₙ(ν) is the difference between two normalized powers at two closely-spaced optical frequencies (centered at ν), ν−½Δν and ν+½Δν. In this calculation, the normalized power, Tₙ(ν), at any frequency (ν) should be first “equalized”, i.e., treated as if there were no ASE or other unpolarized light, by dividing the computed relative variance determined from T(λ) (λ=c/ν) by the Stokes vector magnitude. The normalized powers (i.e., transmission) are then distributed between 0 and 1 for any random pair of input SOP and output SOP. The normalization and equalization procedures are detailed in U.S. Pat. No. 9,829,429 (commonly owned by the Applicant and hereby incorporated by reference). If the DGD is measured for several network channels, and assuming that the channels are sufficiently mutually spaced so that the DGD behavior of each channel is not closely correlated with the others, then the PMD may be estimated via:

$$P M D \approx \sqrt{{\sum }_{i = 1}^{N} {τ}^{2} ( {𝓋}_{i} )} \qquad ( 22 )$$

PDL Measurement with Pol-Mux Signals

Submarine cables usually consist of more than hundreds of optical active and passive components inducing not negligible polarization dependent loss or gain (PDL/G). Like DGD, the accumulated PDL/G depends on PDL/G couplings between PDL/G elements, which varies in wavelength and time. When Pol-Mux signals or (depolarized) ASE passing through PDL/G elements in the cable, the degree of polarization of the signals and the ASE increases. The wavelength dependent PDL/G(ν) can be evaluated as:

$$\begin{matrix}PDL / G ( 𝓋 ) = {T}_{max} ( 𝓋 ) / {T}_{min} ( 𝓋 ) \\ = {P}_{max} ( 𝓋 ) / {P}_{min} ( 𝓋 )\end{matrix} \qquad ( 23 )$$

### Example of VSOP-OSA Device Architecture

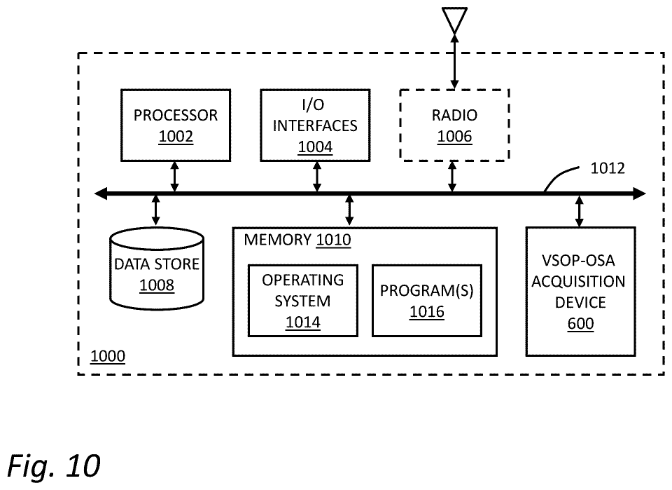

FIG. 10 is a block diagram of a VSOP-OSA device 1000 which may embody the VSOP-OSA unit 324 of the system of FIG. 3. The VSOP-OSA device 1000 may comprise a digital device that, in terms of hardware architecture, generally includes a processor 1002, input/output (I/O) interfaces 1004, a data store 1008, a memory 1010, as well as an optical test device including a VSOP-OSA acquisition device 1018. It should be appreciated by those of ordinary skill in the art that FIG. 10 depicts the VSOP-OSA device 1000 in a simplified manner, and a practical embodiment may include additional components and suitably configured processing logic to support known or conventional operating features that are not described in detail herein. A local interface 1012 interconnects the major components. The local interface 1012 can be, for example, but not limited to, one or more buses or other wired or wireless connections, as is known in the art. The local interface 1012 can have additional elements, which are omitted for simplicity, such as controllers, buffers (caches), drivers, repeaters, and receivers, among many others, to enable communications. Further, the local interface 1012 may include address, control, and/or data connections to enable appropriate communications among the aforementioned components.

The processor 1002 is a hardware device for executing software instructions. The processor 1002 may comprise one or more processors, including central processing units (CPU), auxiliary processor(s) or generally any device for executing software instructions. When the VSOP-OSA device 1000 is in operation, the processor 1002 is configured to execute software stored within the memory 1010, to communicate data to and from the memory 1010, and to generally control operations of the VSOP-OSA device 1000 pursuant to the software instructions. In an embodiment, the processor 1002 may include an optimized mobile processor such as optimized for power consumption and mobile applications. The I/O interfaces 1004 can be used to receive user input from and/or for providing system output. User input can be provided via, for example, a keypad, a touch screen, a scroll ball, a scroll bar, buttons, barcode scanner, and the like. System output can be provided via a display device such as a liquid crystal display (LCD), touch screen, and the like, via one or more LEDs or a set of LEDs, or via one or more buzzer or beepers, etc. The I/O interfaces 1004 can be used to display a graphical user interface (GUI) that enables a user to interact with the VSOP-OSA device 1000 and/or output at least one of the values derived by the VSOP-OSA analyzing module.

The radio 1006, if included, may enable wireless communication to an external access device or network. Any number of suitable wireless data communication protocols, techniques, or methodologies can be supported by the radio 1006, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; Long Term Evolution (LTE); cellular/wireless/cordless telecommunication protocols (e.g. 3G/4G, etc.); NarrowBand Internet of Things (NB-IoT); Long Term Evolution Machine Type Communication (LTE-M); magnetic induction; satellite data communication protocols; and any other protocols for wireless communication.

The data store 1008 may be used to store data, such as OSA traces and VSOP-OSA measurement data files. The data store 1008 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 1008 may incorporate electronic, magnetic, optical, and/or other types of storage media.

The memory 1010 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 1010 may incorporate electronic, magnetic, optical, and/or other types of storage media. Note that the memory 1010 may have a distributed architecture, where various components are situated remotely from one another, but can be accessed by the processor 1002. The software in memory 1010 can include one or more computer programs, each of which includes an ordered listing of executable instructions for implementing logical functions. In the example of FIG. 10, the software in the memory 1010 includes a suitable operating system (O/S) 1014 and computer programs 1016. The operating system 1014 essentially controls the execution of other computer programs and provides scheduling, input-output control, file and data management, memory management, and communication control and related services. The program(s) 1016 may include various applications, add-ons, etc. configured to provide end-user functionality with the VSOP-OSA device 1000. For example, example programs 1016 may include a web browser to connect with a server for transferring OSA measurement data files, a dedicated VSOP-OSA application configured to control VSOP-OSA acquisitions by the VSOP-OSA acquisition device 1018, set VSOP-OSA acquisition parameters, analyze OSA traces obtained by the VSOP-OSA acquisition device 1018 and optionally display a GUI related to the VSOP-OSA device 1000. For example, the dedicated VSOP-OSA application may embody an VSOP-OSA analysis module configured to analyze acquired OSA traces in order to characterize the optical fiber link under test, and produce VSOP-OSA measurement data files.

It is noted that, in some embodiments, the I/O interfaces 1004 may be provided via a physically distinct mobile device (not shown), such as a handheld computer, a smartphone, a tablet computer, a laptop computer, a wearable computer or the like, e.g., communicatively coupled to the VSOP-OSA device 1000 via the radio 106. In such cases, at least some of the programs 1016 may be located in a memory of such a mobile device, for execution by a processor of the physically distinct device. The mobile may then also include a radio and be used to transfer VSOP-OSA measurement data files toward a remote test application residing, e.g., on a server.

It should be noted that the VSOP-OSA device shown in FIG. 10 is meant as an illustrative example only. Numerous types of computer systems are available and can be used to implement the VSOP-OSA device.

The embodiments described above are intended to be exemplary only and one skilled in the art will recognize that numerous modifications can be made to these embodiments without departing from the scope of the invention.

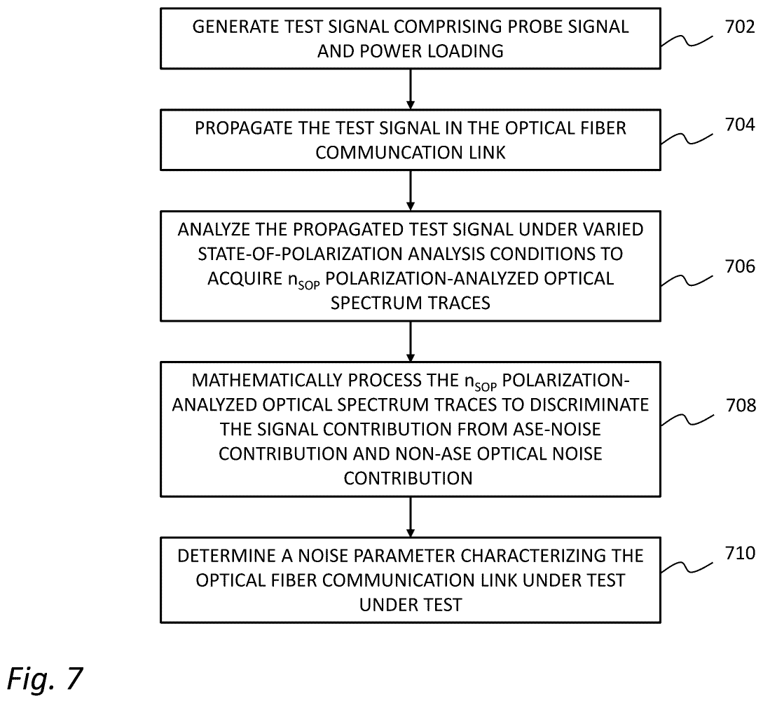

For instance, the dual-channel Varied-SOP polarization-resolved OSA (VSOP-OSA) of FIG. 6 may be replaced by a single-channel Varied-SOP polarization-resolved OSA 802. More specifically, as illustrated in FIG. 8, a polarizer 804 may be disposed at the input of a single-channel polarization-independent OSA 802. As in FIG. 6, a polarization scrambler 806 is positioned upstream to provide a plurality of SOP analysis conditions.

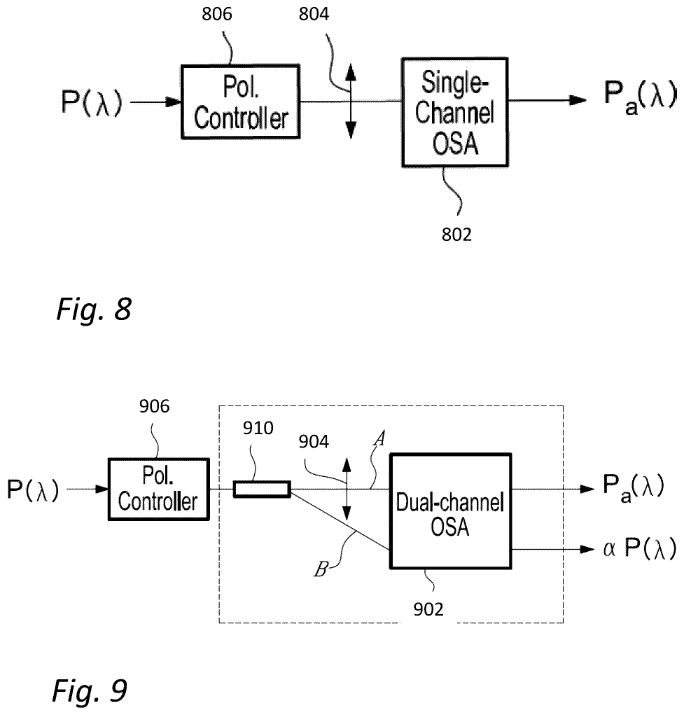

In yet another implementation illustrated in FIG. 9, a non-polarization-dependent beam splitter 910 is used to split the input power between the two channels of a dual-channel polarization-independent OSA 902. A polarizer 904 may be disposed at the input of a first one of the two channels, whereas the second channel receives light from the non-polarization-dependent beam splitter 910. The optical spectrum trace acquired from the second channel may be used to normalize the detected spectrum, thereby rendering the measurements substantially insensitive to variations in the input optical power. Again, as in FIG. 6, a polarization scrambler 906 is positioned upstream to provide a plurality of SOP analysis conditions. In this case, one channel of the OSA 902 becomes polarization-resolved, whereas the other channel remains polarization-independent. Of course, other implementations may further be envisaged.

Although the present disclosure has been illustrated and described herein with reference to specific embodiments and examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims.

1. A method for determining at least one noise parameter characterizing an optical fiber communication link under test within an optical transmission channel under test, independently of terminal equipment, said method comprising:
generating a test signal comprising a polarized probe signal within the optical transmission channel under test, and power loading light in a plurality of channels outside the optical transmission channel under test;
propagating the test signal in the optical fiber communication link under test from one end thereof;
on the other end of the optical communication link under test, analyzing the propagated test signal using a varied-SOP polarization-resolved Optical Spectral Analyzer (VSOP-OSA), said analyzing comprising acquiring, for each of a number n_{SOP} of varied state-of-polarization analysis conditions, at least one polarization-analyzed optical spectrum trace, the propagated test signal comprising a probe signal contribution, an ASE-noise contribution and a non-linear optical noise contribution within said optical transmission channel;
mathematically discriminating said probe signal contribution from at least said non-linear optical noise contribution using the polarization-analyzed optical spectrum traces acquired under varied state-of-polarization analysis conditions; and
determining said at least one noise parameter characterizing said optical fiber communication link under test under test within said optical transmission channel using said probe signal contribution and at least the discriminated non-linear optical noise contribution.

2. The method as claimed in claim 1, wherein said noise parameter comprises a Non-Linear Effect Factor (NLEF).

3. The method as claimed in claim 1, wherein said noise parameter comprises a Non-Linear Optical Signal to Noise Ratio (OSNR_{NLE}).

4. The method as claimed in claim 1, wherein said mathematically discriminating comprises:
from the polarization-analyzed optical spectrum traces, determining an extrema trace; and
wherein said discriminating is made using said extrema trace.

5. The method as claimed in claim 1, wherein said mathematically discriminating comprises: determining a coefficient of signal depolarization.

6. The method as claimed in claim 1, wherein said mathematically discriminating comprises:
mathematically discriminating said probe signal contribution from said ASE-noise contribution and said non-linear optical noise contribution using the polarization-analyzed optical spectrum traces acquired under varied state-of-polarization analysis conditions; and
determining said at least one noise parameter characterizing said optical fiber communication link under test within said optical transmission channel at least from the discriminated ASE optical noise contribution.

7. The method as claimed in claim 6, where said ASE noise parameter comprises an ASE-only Optical Signal to Noise Ratio (OSNR_{ASE}).

8. The method as claimed in claim 6, wherein said at least one noise parameter comprises a Generalized Optical Signal to Noise Ratio (GOSNR).

9. The method as claimed in claim 1, wherein said polarized probe signal is a continuous wave signal.

10. The method as claimed in claim 1, wherein said test signal comprises a plurality of polarized probe signals within a corresponding plurality of optical transmission channels under test in order to test said plurality of optical transmission channels simultaneously, and power loading light in a plurality of channels outside the optical transmission channels under test.

11. The method as claimed in claim 10, wherein said power loading light comprises unpolarized broadband light.

12. The method as claimed in claim 1, further comprising characterizing polarization effects comprising at least one of a Polarization Dependent Loss (PDL), a Differential Group Delay (DGD)) and a Polarization Mode Dispersion (PMD) along the optical fiber communication link.

13. A test system for determining at least one noise parameter characterizing an optical fiber communication link under test within an optical transmission channel, independently of terminal equipment, the test system comprising:
a polarized light source to generate a polarized probe signal within the optical transmission channel under test;
a power loading light source to generate power loading light in a plurality of channels outside the optical transmission channel under test;
wherein said probe signal and said power loading light are combined to generate a test signal to be propagated in the optical fiber communication link under test from one end thereof;
a varied-SOP polarization-resolved Optical Spectral Analyzer (VSOP-OSA) on the other end of the optical communication link under test, to analyze the test signal having propagated in the optical fiber communication link under test, said VSOP-OSA comprising a polarization scrambler to acquire, for each of a number n_{SOP} of varied state-of-polarization analysis conditions, at least one polarization-analyzed optical spectrum trace, the propagated test signal comprising a probe signal contribution, an ASE-noise contribution and a non-linear optical noise contribution within said optical transmission channel; and
a processing unit receiving the polarization-analyzed optical spectrum traces acquired under varied state-of-polarization analysis conditions and configured to:
mathematically discriminate said probe signal contribution from at least said non-linear optical noise contribution using the polarization-analyzed optical spectrum traces acquired under varied state-of-polarization analysis conditions; and
determine said at least one noise parameter characterizing said optical fiber communication link under test under test within first optical transmission channel using said probe signal contribution and at least the discriminated non-linear optical noise contribution.

14. The test system as claimed in claim 13, wherein said processing unit is further configured to:
mathematically discriminate said probe signal contribution from said ASE-noise contribution and said non-linear optical noise contribution using the polarization-analyzed optical spectrum traces acquired under varied state-of-polarization analysis conditions; and
determine said at least one noise parameter characterizing said optical fiber communication link under test within said optical transmission channel at least from the discriminated ASE optical noise contribution.

15. The test system as claimed in claim 14, wherein said at least one noise parameter comprises at least one of an ASE-only Optical Signal to Noise Ratio (OSNR_{ASE}), a Non-Linear Effect Factor (NLEF), an non-linear Optical Signal to Noise Ratio (OSNR_{NLE}) and a Generalized Optical Signal to Noise Ratio (GOSNR).

16. The test system as claimed in claim 13, wherein said a polarized light source comprises a plurality of polarized light sources to generate a corresponding plurality of polarized probe signals within a plurality of optical transmission channels under test in order to test said plurality of optical transmission channels simultaneously; and wherein said power loading light source generates power loading light in a plurality of channels outside said optical transmission channels under test.

17. The test system as claimed in claim 13, wherein said power loading light source comprises an unpolarized broadband light source.

18. The test system as claimed in claim 13, further comprising a polarization scrambler on said one end of the optical communication link under test to characterize polarization effects comprising at least one of a Polarization Dependent Loss (PDL), a Differential Group Delay (DGD)) and a Polarization Mode Dispersion (PMD) along the optical fiber communication link.
